(19) United States
(12) Patent Application Publication
(10) Pub. No.: US 2021/0237318 A1
(43) Pub. Date: Aug. 5, 2021

(54) Method for Producing a Component Having a Surface Provided With a Surface Texture

(71) Applicant: Bayerische Motoren Werke Aktiengesellschaft, Muenchen (DE)

(72) Inventors: Martin FRIEDRICH, Unterschleissheim (DE); Lukas KNORR, Muenchen (DE)

(21) Appl. No.: 16/972,532

(22) PCT Filed: May 24, 2019
(86) PCT No.: PCT/EP2019/063420

§ 371 Date: Dec. 4, 2020

(30) Foreign Application Priority Data
Jun. 21, 2018 (DE) 10 2018 210 117.5

(51) Int. Cl. B29C 35/02; B29C 41/34; B29C 41/22; B29C 59/02

(52) U.S. Cl. CPC B29C 35/0266; B29C 41/34; B33Y 10/00; B29C 59/02; B29C 41/22

(57) ABSTRACT

A method for producing a component includes forming a component body having a surface by an additive build-up operation from a hardenable material which is built up in an additive manner or providing the component body having the surface which is formed by the additive build-up operation from the hardenable material which is built up in the additive manner. The method further includes hardening the surface of the component body and forming a surface texture on the surface of the component body prior to the hardening of the surface of the component body and/or during the hardening of the surface of the component body.

### BACKGROUND AND SUMMARY OF THE INVENTION

The invention relates to a method for producing a component having a surface provided with a surface texture, comprising the steps of: forming or providing a component body having at least one surface to be provided with a surface texture, wherein the component body is or has been formed, by way of an additive build-up operation, from a hardenable material which can be built up in an additive manner, wherein the component body can be hardened at least in the region of the at least one surface to be provided with a surface texture, and hardening at least the surface of the component body to form the component to be produced.

To produce components which have a surface provided with a surface texture, various approaches in terms of manufacturing technology are known from the prior art.

In connection with the additive build-up of corresponding components, it has been known to attempt to form corresponding surface textures in respective surfaces of the components directly by way of additive build-up processes, that is to say to “print” corresponding surface textures.

Here, however, there are a range of difficulties, which arise, inter alia, as a result of the resolution of the additive build-up apparatuses, the resolution being only partially sufficient with regard to the typically very fine surface textures, and also the very large amounts of data which are required for the additive formation of corresponding surface textures. The additive build-up of corresponding surface textures has thus hitherto been considered to be comparatively cost- and time-intensive.

The invention is based on the object of specifying a method, which is improved compared with the above, for producing a component having a surface provided with a surface texture.

The object is achieved by a method for producing a component having a surface provided with a surface texture.

The method described herein is used to produce a component having at least one surface provided with a surface texture. A surface texture is typically understood to mean a decorative three-dimensional embossing or design of the surface of the component.

In general, the component which can be produced or is to be produced according to the method is typically a component of a motor vehicle or of a motor vehicle body. In particular, the component which can be produced or is to be produced according to the method is a trim element, that is to say in particular an interior trim element, for a motor vehicle or a motor vehicle body.

The method comprises the steps which are explained in more detail below:

In a first step of the method, at least one component body having at least one surface to be provided with a surface texture is formed. The component body is formed, by way of an additive build-up operation, from a hardenable material which can be built up in an additive manner. Since the hardenable material, as emerges hereinafter, is typically a plastics material or a material based on at least one plastics material, particular consideration is given to additive build-up processes for the formation of the component body with which plastics materials or materials based on at least one plastics material can be built up in an additive manner. Examples thereof are stereolithography processes or fused layer deposition processes (FDM processes); the list is non-exhaustive.

The additive build-up of the component body is typically performed on the basis of building data which describe the geometry of the component body. The building data can be generated with regard to a load-compliant design of the component body or of the subsequent component. The building data can be generated concretely for example with regard to specific structural properties, that is to say in particular mechanical properties, such as, for example, elasticity or viscoelasticity, strength, stiffness, energy absorption capacity, etc., of the component body or of the subsequent component. Furthermore, the building data can (also) be generated with regard to specific acoustic, optical, thermal properties of the component body or of the subsequent component.

Instead of forming a corresponding component body by way of an additive build-up operation, in the context of the method, it is also possible to provide a corresponding additively built-up component body in the first step.

In all cases, the additively built-up component body, regardless of whether the latter has been formed or provided according to the method, can be hardened at least in the region of the at least one surface to be provided with a surface texture and is thus not yet completely hardened. The component body therefore has hardenable properties at least in the region of the at least one surface to be provided with a surface texture. Typically, the (entire) component body therefore obtains the structural properties thereof, which are required for the intended use assigned to it, only after a yet-to-be-performed hardening operation.

In a second step of the method, at least the surface of the component body is hardened to form the component to be produced. In the second step of the method, to form the component to be produced, at least one measure for hardening at least the surface of the component body is therefore performed. The measure is typically selected with regard to the hardenable material. If, for example, it is a thermally hardenable material, the measure typically involves the use of thermal energy; for the hardening, the component body to be hardened can therefore be brought, for example, into a heating device, such as, for example, a furnace, and be stored and heated there for a specific amount of time. If, for example, it is a material which can be hardened by electromagnetic radiation, that is to say in particular light of a certain wavelength, the measure typically involves the use of electromagnetic radiation; for the hardening, the component body to be hardened can therefore be brought, for example, into an irradiating device and be stored and irradiated there for a specific amount of time. A chemically initiated hardening of the hardenable material is also conceivable.

In principle, particularly for multi-constituent hardenable materials, combined hardening operations are also conceivable; here, it may for example be the case that a first constituent of the hardenable material is hardened by a first measure, that is to say for example by thermal energy, and a second constituent of the hardenable material is hardened by a second measure, that is to say for example by electromagnetic radiation.

As has already been indicated further above, it should be noted that the hardenable material is typically a plastics material or a material based on at least one plastics material. Specifically, the hardenable material may for example be a single-constituent or multi-constituent, thermoplastic or thermosetting resin.

It is essential to the method described herein that the surface texture in the at least one surface of the component body is formed prior to the hardening and/or during the hardening of the surface of the component body. The method therefore takes advantage of the hardenable properties of the surface of the component body in order to form or to generate a surface texture. The surface texture is therefore formed in a state of the surface of the component body in which the surface of the component body can still be hardened and thus can still be deformed. The hardenable or deformable properties of the surface of the component body therefore make it possible to form or generate the surface texture in the surface of the component body.

In this case, the surface texture is formed in particular by applying—this is possibly also understood to mean spreading, scattering or spraying—a particle structure, which generates a surface texture in the surface of the component body, onto the surface of the component body. Here, the particle structure has properties which generate and thus shape the surface texture, or a surface which generates and thus shapes the surface texture, such that, as a result of application of the particle structure onto the, as mentioned, deformable surface of the component body, a surface texture can be generated in the surface of the component body. The surface texture can therefore be generated by deformation of the surface of the component body as a result of application of the particle structure onto the surface of the component body.

In order to obtain a particularly clear formation or generation of the surface texture, it may be expedient for the particle structure to be applied or pressed with a specific pressure or contact pressure onto the surface of the component body, and/or for the surface of the component body to be pressed with a specific pressure or contact pressure against the particle structure. The application of a corresponding pressure or contact pressure may also be expedient for realizing a certain compression at least of the surface of the component body.

The particle structure used can for example be a particulate granular material comprising loose particles and/or loose particle agglomerates. In particular in this embodiment of the particle structure, the aforementioned spreading or scattering or spraying comes into consideration. The particles or the particle agglomerates of the particulate granular material typically have a granular form (morphology). The geometric properties of the surface texture result substantially from the form of the particles or of the particle agglomerates. The geometric properties of the surface texture can also be influenced via other parameters of the particulate granular material, that is to say in particular the particle size-related composition of the particulate granular material. In particular, with regard to the geometric properties of the surface texture, particular importance is therefore attached to the distribution of the particle sizes or particle agglomerate sizes in the particulate granular material; in other words, the geometric properties of the surface texture can be influenced in a targeted manner by the targeted selection for example of the distribution of the particle sizes or particle agglomerate sizes in the particulate granular material.

As an alternative or in addition, the particle structure used can be a planar structure having a particle surface. A particle surface is typically understood to mean a surface having a particulate, that is to say in particular granular, structure. The principle for forming or generating the surface texture is analogous to the use of a particulate granular material, such that corresponding observations in connection with the particulate granular material apply in an analogous manner.

Use can be made of an, in particular flat, planar structure which has, at least on one side, a defined particle surface. The use of a carrier element with particles and/or particle agglomerates fastened at least on one side thereof is conceivable, for example. The particles or particle agglomerates can form the particle surface of the carrier element. A corresponding carrier element can therefore have, at least on one side, a particle surface which is defined by corresponding particles and/or particle agglomerates.

A carrier element can for example be of film-like or film-shaped configuration, and thus the carrier element can for example be a film. A corresponding film-like or film-shaped carrier element can inherently have, at least on one side, a defined particle surface. Otherwise, particles and/or particle agglomerates, if present, can be fastened on the carrier element, that is to say in particular a corresponding film, for example by adhesive bonding. A film-like or film-shaped carrier element can be removed from the component body for example by simple peeling of the element off from the component body.

In principle, it is also conceivable to use, as particle structure, a planar structure having a surface texture surface, that is to say already having a surface texture or an image of a surface texture.

For all embodiments of a corresponding particle structure, it holds true that the latter can be dissolved in at least one solvent. Thus, use can be made of a particle structure which can be dissolved in at least one solvent. As an alternative or in addition, use can be made of a thermally decomposable particle structure. After the surface texture has been formed or generated, the particle structure can therefore be removed in a simple and thus practical manner by a solvent and/or by application of thermal energy, for example in a burn-out operation. In this case, care must be taken to ensure that the component body is not damaged, that is to say, for example, that there are no undesired interactions between the solvent and the component body. This can also apply for the carrier element; thus, in particular solvent-soluble carrier elements come into consideration.

A conceivable solvent is for example water, and therefore it is for example possible to use a water-soluble particle structure. Particular consideration is therefore given to water-soluble particles or particle agglomerates as particles or particle agglomerates. In particular, in this connection, water-soluble salts or salt compounds should be contemplated. Salts or salt compounds can also be expedient on account of their typically high thermal stability.

In order to form or to generate a sufficiently fine surface texture, a particle structure having a (mean) particle size in a range of between 10 and 100 μm, in particular in a range of between 10 and 75 μm, can be used. The particle size of the particle structure should fundamentally be selected with regard to the resolution of the additive build-up apparatus which is used for the additive build-up of the component body, wherein the particle size should typically be set below the (maximum) resolution of the additive build-up apparatus. It goes without saying that, in exceptional cases, it is also possible to use a particle structure having a (mean) particle size in a range below 10 μm or above 100 μm.

In addition to the method, the invention also relates to a component which is produced according to the method. All of the observations in connection with the method therefore apply in an analogous manner for the component.

One exemplary embodiment of the invention is explained in more detail below in connection with the drawings.

### BRIEF DESCRIPTION OF THE DRAWINGS

FIGS. 1-3 show a respective step of a method for producing a component having a surface provided with a surface texture according to one exemplary embodiment.

### DETAILED DESCRIPTION OF THE DRAWINGS

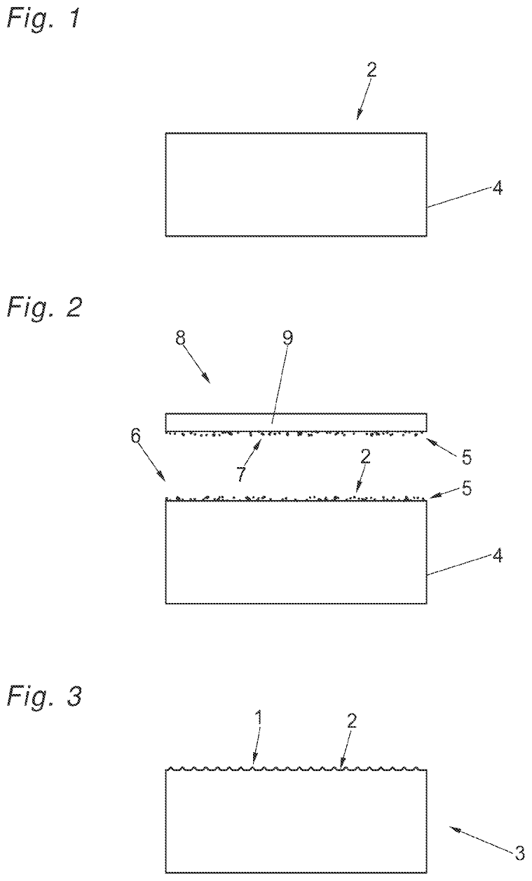

FIGS. 1-3 show a respective step of a method for producing a component 3 having a surface 2 provided with a surface texture 1 according to one exemplary embodiment.

The component 3 which can be produced or is to be produced according to the method is a component of a motor vehicle or of a motor vehicle body. In particular, the component 3 which can be produced or is to be produced according to the method is a trim element, that is to say in particular an interior trim element, for a motor vehicle or a motor vehicle body.

The method comprises the steps which are explained in more detail below:

In a first step of the method, at least one component body 4 having at least one surface to be provided with a surface texture is formed. The component body 4 is formed, by way of an additive build-up operation, from a hardenable material which can be built up in an additive manner. The hardenable material is a plastics material or a material based on at least one plastics material, that is to say is for example a single-constituent or multi-constituent, thermoplastic or thermosetting resin. The component body 4 may have been built up in an additive manner for example by means of a stereolithography process or a fused layer deposition process (FDM process).

Instead of forming the component body 4 by way of an additive build-up operation, it would also be possible to provide a corresponding additively built-up component body 4 in the first step.

FIG. 1 shows the component body 4 (in a purely schematic view) directly after the additive build-up.

The additively built-up component body 4, regardless of whether the latter has been formed or provided according to the method, can be hardened at least in the region of the surface 2 to be provided with a surface texture 1 and is thus not yet completely hardened. The component body 4 therefore has hardenable properties at least in the region of the surface 2 to be provided with the surface texture 1. The (entire) component body 4 therefore obtains the structural properties thereof, which are required for the intended use assigned to it, only after a yet-to-be-performed hardening operation.

In a second step of the method, at least the surface 2 of the component body 4 is hardened to form the component 3 to be produced. In the second step of the method, to form the component 3 to be produced, at least one measure for hardening at least the surface 2 of the component body 4 is therefore performed. The measure is typically selected with regard to the hardenable material. If, for example, it is a thermally hardenable material, the measure typically involves the use of thermal energy; for the hardening, the component body 4 to be hardened can therefore be brought, for example, into a heating device, such as, for example, a furnace, and be stored and heated there for a specific amount of time. If, for example, it is a material which can be hardened by electromagnetic radiation, that is to say in particular light of a certain wavelength, the measure typically involves the use of electromagnetic radiation; for the hardening, the component body 4 to be hardened can therefore be brought, for example, into an irradiating device and be stored and irradiated there for a specific amount of time. A chemically initiated hardening of the hardenable material is also conceivable.

According to the method, the surface texture in the surface 2 of the component body 4 is formed prior to the hardening and/or during the hardening of the surface 2 of the component body 4. The method therefore takes advantage of the hardenable properties of the surface 2 of the component body 4 in order to form or to generate a surface texture. The surface texture is therefore formed in a state of the surface 2 of the component body 4 in which the surface 2 of the component body 4 can still be hardened and thus can still be deformed. The hardenable or deformable properties of the surface 2 of the component body 4 therefore make it possible to form or generate the surface texture in the surface 2 of the component body 4.

In this case, the surface texture 1 is formed in particular by applying a particle structure 5, which generates a surface texture 1 in the surface 2 of the component body 4, onto the surface 2 of the component body 4. Here, the particle structure 5 has properties which generate and thus shape the surface texture 1, or a shaping surface, such that, as a result of application of the particle structure 5 onto the, as mentioned, deformable surface 2 of the component body 4, a surface texture 1 can be generated in the surface 2 of the component body 4. The surface texture 1 can therefore be generated by deformation of the surface 2 of the component body 4 as a result of application of the particle structure 5 onto the surface 2 of the component body 4.

In order to form or to generate a sufficiently fine surface texture 1, a particle structure 5 having a (mean) particle size in a range of between 10 and 100 μm, in particular in a range of between 10 and 75 μm, can be used.

In order to obtain a particularly clear formation or generation of the surface texture 1, it may be expedient for the particle structure 5 to be applied or pressed with a specific pressure or contact pressure onto the surface 2 of the component body 4, and/or for the surface 2 of the component body 4 to be pressed with a specific pressure or contact pressure against the particle structure 5. The application of a corresponding pressure or contact pressure may also be expedient for realizing a certain compression of the surface 2 of the component body 4.

On the basis of FIG. 2, it can be seen that the particle structure 5 used can be a particulate granular material 6 comprising loose particles and/or loose particle agglomerates. The particulate granular material 6 may have been spread on, scattered on or sprayed on, for example. The particles or the particle agglomerates of the particulate granular material 6 typically have a granular form (morphology). The geometric properties of the surface texture 1 result substantially from the form of the particles or of the particle agglomerates. The geometric properties of the surface texture 1 can also be influenced via other parameters of the particulate granular material 6, that is to say in particular the particle size-related composition of the particulate granular material 6. The geometric properties of the surface texture 1 can therefore be influenced in a targeted manner by the targeted selection for example of the distribution of the particle sizes or particle agglomerate sizes in the particulate granular material 6.

On the basis of FIG. 2, it can further be seen that the particle structure 5 used is a planar structure 8 having a particle surface 7. A particle surface 7 is understood to mean a surface having a particulate, that is to say in particular granular, structure. The principle for forming or generating the surface texture 1 is analogous to the use of a particulate granular material 6.

As shown in exemplary fashion in FIG. 2, use can be made of a planar structure 8 which has an, in particular flat, carrier element 9 with particles and/or particle agglomerates fastened thereon. The carrier element 9 can therefore have, at least on one side, a particle surface 7 which is defined by corresponding particles and/or particle agglomerates. The particles and/or particle agglomerates can be fastened on the carrier element 9 by adhesive bonding.

It is also conceivable to use a carrier element 9 which inherently has a corresponding particle surface 7 and on which, on account of its surface structure which inherently has a corresponding particle surface 7, it is therefore not necessary to fasten any separate particles and/or particle agglomerates. However, in principle, this is of course nevertheless possible.

The carrier element 9 can be of film-like or film-shaped configuration, and thus the carrier element 9 can be a film. Such a carrier element 9 can be removed by simple peeling of the element off from the component body 4.

In principle, it is also conceivable to use, as particle structure 5, a planar structure 8 having a surface texture surface, that is to say already having a surface texture or an image of a surface texture.

The particle structure 5 can be dissolved in at least one solvent. After the surface texture 1 has been formed or generated, the particle structure 5 can therefore be removed in a simple and thus practical manner by a solvent. In this case, care must be taken to ensure that there are no undesired interactions between the solvent and the component body 4. This can also apply for the carrier element 9; thus, in particular solvent-soluble carrier elements 9 come into consideration.

A conceivable solvent is for example water, and therefore it is for example possible to use a water-soluble particle structure 5. Particular consideration is therefore given to water-soluble particles or particle agglomerates as particles or particle agglomerates. In particular, in this connection, water-soluble salts or salt compounds should be contemplated. Salts or salt compounds can also be expedient on account of their typically high thermal stability.

It is likewise conceivable to use a thermally decomposable particle structure 5. Such a particle structure 5 can be removed by application of thermal energy, for example in a burn-out operation.

FIG. 3 shows the component 3 (in a purely schematic view) after removal of the particle structure 5 and thus in the finished state.

1.-11. (canceled)

12. A method for producing a component, comprising the steps of:
forming a component body having a surface by an additive build-up operation from a hardenable material which is built up in an additive manner or providing the component body having the surface which is formed by the additive build-up operation from the hardenable material which is built up in the additive manner;
hardening the surface of the component body; and
forming a surface texture on the surface of the component body prior to the hardening of the surface of the component body and/or during the hardening of the surface of the component body.

13. The method according to claim 12, wherein the surface texture is formed by applying a particle structure, which generates the surface texture on the surface of the component body, onto the surface of the component body.

14. The method according to claim 13, wherein the particle structure is a particulate granular material comprising loose particles and/or loose particle agglomerates.

15. The method according to claim 13, wherein the particle structure is a planar structure having a particle surface.

16. The method according to claim 15, wherein the planar structure is a carrier element with particles and/or particle agglomerates fastened on the carrier element by adhesive bonding.

17. The method according to claim 13, wherein the particle structure is dissolvable, at least partially, in a solvent and/or is thermally decomposable.

18. The method according to claim 13, wherein the particle structure is water-soluble.

19. The method according to claim 13, wherein the particle structure has particles with a size in a range of between 10 and 100 μm.

20. The method according to claim 13, wherein the particle structure is pressed with a contact pressure onto the surface of the component body and/or wherein the surface of the component body is pressed with a contact pressure against the particle structure.

21. The method according to claim 12, wherein the hardening is effected by thermal energy and/or energy radiation.

22. A component, comprising:
a surface with a surface texture, wherein the component is produced by the method according to claim 12.
